(19) United States
(12) Patent Application Publication
(10) Pub. No.: US 2015/0372285 A1
(43) Pub. Date: Dec. 24, 2015

(54) Metal Hydride Battery Electrodes

(71) Applicant: BASF Corporation, Florham Park, NJ (US)

(72) Inventors: Baoquan Huang, Troy, NY (US); Kwo Young, Troy, NY (US); John Koch, Brighton, MI (US)

(21) Appl. No.: 14/313,345

(22) Filed: Jun. 24, 2014

(51) Int. Cl. H01M 4/04; H01M 4/62; H01M 4/70; H01M 4/1399; H01M 4/72; H01M 4/74; H01M 4/52; H01M 10/30; H01M 4/66

(52) U.S. Cl. CPC H01M 4/0402; H01M 10/30; H01M 4/622; H01M 4/623; H01M 4/70; H01M 4/661; H01M 4/72; H01M 4/74; H01M 4/52; H01M 4/1399; H01M 4/0471

(57) ABSTRACT

Rechargeable metal hydride alkaline cells are provided improved cycle life, lower internal resistance and enhanced utilization of energy by employing a positive electrode prepared by a method comprising applying a paste comprising an active positive electrode composition to a conductive substrate and exposing the pasted electrode to elevated temperature for a desired time period. The electrode composition comprises a particulate positive electrode active material, a polymeric binder and optionally one or more additives. The electrode active material is for instance nickel hydroxide or modified nickel hydroxide. In the case of a nickel foam substrate, the electrode composition may contain no binder.

The present invention relates to improved positive electrodes for metal hydride (MH) batteries.

Metal hydride batteries, or rechargeable metal hydride alkaline cells, employ a negative electrode capable of reversible electrochemical hydrogen storage. A typical positive electrode comprises nickel hydroxide active material. The positive electrodes are for instance sintered or pasted.

Sintered electrodes may consist of a porous nickel plaque of sintered high surface area nickel particles impregnated with nickel hydroxide active material either by chemical or electrochemical methods.

Pasted electrodes may comprise nickel hydroxide particles in contact with a conductive substrate. Pasted electrodes are simple to manufacture, for instance by applying a paste comprising active nickel hydroxide particles to a conductive substrate, followed by roll pressing.

Much progress has been made in improving the cycle life of MH cells by optimizing the active materials of the positive and negative electrodes. The present invention concerns optimizing electrode integrity to improve cycle life.

Disclosed is a method for preparing a positive electrode for a metal hydride cell, the method comprising

applying a paste comprising an active positive electrode composition to a conductive substrate to obtain a pasted electrode and

exposing the pasted electrode to an elevated temperature of from about 130° C. to about 210° C., for instance from about 140° C. to about 190° C. or from about 140° C. to about 180° C.; or at a temperature of about 150° C., 160° C., 170° C. or 200° C.,

where the electrode composition comprises a particulate positive electrode active material, a polymeric binder and optionally one or more additives.

Also disclosed is a method for preparing a positive electrode for a metal hydride cell, the method comprising

applying a paste comprising an active positive electrode composition to a conductive nickel foam substrate to obtain a pasted electrode and

exposing the pasted electrode to an elevated temperature of from about 130° C. to about 210° C., for instance from about 140° C. to about 190° C. or from about 140° C. to about 180° C.; or at a temperature of about 150° C., 160° C., 170° C. or 200° C.,

where the electrode composition comprises a particulate positive electrode active material and optionally one or more additives.

### DETAILED DISCLOSURE

Present metal hydride cells, or rechargeable alkaline cells, comprise at least one negative electrode capable of reversibly charging and discharging hydrogen, at least one positive electrode capable of reversible oxidation, a casing having said electrodes positioned therein, a separator separating the negative and positive electrodes and an alkaline electrolyte in contact with the electrodes.

The active materials of the positive electrodes participate in the charge/discharge reactions. The active materials are nickel hydroxide active materials, that is nickel hydroxide or modified nickel hydroxide. Nickel hydroxide active materials and their preparation are taught for instance in U.S. Pat. Nos. 5,348,822, 5,637,423, 5,366,831, 5,451,475, 5,455,125, 5,466,543, 5,498,403, 5,489,314, 5,506,070, 5,571,636, 6,177,213, 6,228,535, 6,617,072 and 7,396,379. Modified nickel hydroxide may contain one or more modifiers such as Co, Cd, Ag, V, Sb, Ca, Mg, Al, Bi, Cr, Cu, Fe, In, rare earths, Mn, Ru, Sn, Ti, Ba, Si, Sr or Zn, as taught for instance in U.S. Pat. No. 6,228,535. A suitable modified nickel hydroxide is (Ni,Co,Zn)(OH)₂, for instance in the form of a spherical powder. In modified nickel hydroxides, nickel generally is present at a level of ≧80 atomic percent, for instance ≧90 atomic percent, based on the metals.

The active material of the negative electrode comprises an ABₓ type alloy capable of storing hydrogen where x is from about 0.5 to about 5. A is a hydride forming element and B is a weak or non-hydride forming element. The alloys are capable of reversibly absorbing and desorbing hydrogen. Suitable alloys are for instance taught in U.S. Pat. Nos. 4,623,597, 5,096,667, 5,536,591, 5,840,440, 6,270,719, 6,536,487, 8,053,114, 8,124,281, 7,829,220, 8,257,862 and 8,409,753 and U.S. Pub. Nos. 2013/0277607 and 2006/057019. The present ABx alloys may be prepared for instance via arc melting or induction melting under an inert atmosphere, by melt casting, rapid solidification, mechanical alloying, sputtering or gas atomization or other methods as taught therein.

The ABx type alloys are for example of the categories (with simple examples): AB (HfNi, TiFe, TiNi), AB₂ (Mn₂Zn, TiFe₂), A₂B (Hf₂Fe, Mg₂Ni), AB₃ (NdCo₃, GdFe₃), A₂B₇ (Pr₂,Ni₇, Ce₂Co₇) and AB₅ (LaNi₅, CeNi₅).

The active electrode materials are in particulate form. The particles may be for example platelets, scales, flakes, fibers, spheres or other shapes. The particles are for example substantially spherical, for instance micron scaled spheres. The diameter of particulate spheres is for instance from about 0.1 to about 100 microns on average. The largest radii of platelets or other shapes may also be from about 0.1 to about 100 microns on average.

The conductive substrate relates to any electrically conductive support for an electrode active material. It may be in the form of a foam, grid, screen, mesh, matte, plate, fiber, foil, expanded metal or any other type of support structure. It may take the form of conventional nickel foils, plates and foams, as well as carbon networks, fibers or particulate and cobalt oxyhydroxide networks. It may be made from any electronically conductive material, for example nickel, nickel alloys, copper and copper alloys. For instance, the conductive substrate is nickel, a nickel alloy, nickel plated steel or nickel plated copper. For example the conductive substrate is a nickel foam.

Suitable polymeric binders are taught for example in U.S. Pat. Nos. 5,948,563, 6,171,726, 6,573,004, 6,617,072 and U.S. Pub. No. 2011/0171526.

The polymeric binder is for example a thermoplastic organic polymer, for instance selected from the group consisting of polyvinyl alcohol (PVA), polyethylene oxide, polypropylene oxide, polybutylene oxide, methyl cellulose, carboxymethyl cellulose, hydroxyethyl cellulose, hydroxypropyl cellulose, hydroxypropylmethyl cellulose, polyethylene, polypropylene, polyisobutylene, polyvinyl chloride, polyvinyliden chloride, polyvinyliden fluoride, polytetrafluoroethylene (PTFE), fluorinated ethylene propylene (FEP), perfluroalkoxy (PFA), polyvinylacetate, polyvinyl isobutylether, polyacrylonitrile, polymethacrylonitrile, polymethylmethacrylate, polymethylacrylate, polyethylmethacrylate, allyl acetate, polystyrene, polybutadiene, polyisoprene, polyoxymethylene, polyoxyethylene, polycyclic thioether, polydimethylsiloxane, polyesters such as polyethylene terephthalate, polycarbonate and polyamide. Blends and copolymers of the above are also suitable.

The polymeric binder may also be an elastomer or rubber such as styrene-butadiene copolymer, styrene-butadiene-styrene block copolymer, styrene-isoprene block copolymer, styrene-isoprene-styrene block copolymer, styrene-ethylene-styrene-butadiene block copolymer, styrene-ethylene-butadiene-styrene block copolymer or styrene-acrylonitrile-butadiene-methyl acrylate copolymer.

The binders for instance may have a weight average molecular weight, Mw, of 30,000, for example from about 2,000 to about 35,000 g/mol, for instance from about 2,500 to about 30,000 g/mol, from about 5,000 to about 28,000 g/mol or from about 10,000 to about 26,000 g/mol.

The positive electrode compositions may comprise additives. For instance, the electrode compositions may contain additives such as cobalt compounds, zinc compounds, rare earth compounds or carbon materials. Carbon materials are for instance graphite, graphene, cokes or carbon black.

The positive electrode compositions comprise for instance from about 75 to about 99.8 weight percent (wt %) electrode active material, from about 0.2 to about 10 wt % polymeric binder and from 0 to about 24.8 wt % additives, based on the weight of the electrode composition.

For example, the polymeric binders are present in the electrode compositions at weight levels of about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0 or about 2.1 wt %, based on the weight of the electrode composition.

Alternatively, when the conductive substrate is a nickel foam, the electrode composition may contain no binder. The electrode composition may contain only electrode active material and optional additives. In this case, the positive electrode compositions comprise for instance from about 75 to 100 wt % electrode active material and from 0 to about 25 wt % additives.

The positive electrode compositions may also comprise an appropriate viscosity thickener. Thickeners are for instance cellulosic polymers, salts thereof, polyacrylic acid or polymethacrylic acid or salts thereof and the like. Thickeners may be present in the electrode composition at a level of from about 0.2 wt % to about 1.5 wt %, based on the weight of the composition.

The paste may be a dry paste, comprising the electrode composition and no solvent. Alternatively, the paste may contain the components of the electrode composition and a solvent selected from water, organic solvents and combinations thereof.

Solvents include for instance water and organic solvents such as N-methylpyrrolidone, xylene, toluene, acetone, methanol, ethanol, i-propanol, n-propanol, methylethylketone, cyclohexane, heptane, hexane, tetrahydrofuran and the like.

The polymeric binder may be dissolved, partially dissolved or insoluble in the aqueous or organic solvent. After a paste slurry is applied (pasted) to a conductive substrate, it is typically dried to remove the solvent. The slurry may be allowed to dry at room temperature or may be dried at temperatures up to for instance about 60° C., 70° C., 80° C. or 90° C. Drying may be performed in an oven. The minimum time required for drying is that which results in complete removal of water and/or organic solvent.

After pasting and drying, the electrode may be formed in a press mold or with a roll press or calendar or similar device to achieve the final desired thickness (pressing step). A suitable thickness is for instance from about 21 mil to about 33 mil.

The “application step” is identical to the “pasting step”.

The heat treatment advantageously takes place by exposing the pasted electrode to an elevated temperature of from about 130° C. to about 210° C., for instance from about 140° C. to about 190° C. or from about 140° C. to about 180° C. The heat treatment may take place at about 150° C., 160° C., 170° C. or 200° C.

The heat treatment may take place for instance in an oven. The heat treatment may be performed with a radiant infrared lamp. Suitable sources of heat include convection heating, radiant heating, inductive heating or combinations of these. Each or all of these sources may suitably be combined with microwave radiation.

The order of steps is advantageously pasting, optional drying, pressing and heating. Where drying and heating steps are included, the drying step will advantageously take place at a temperature of at least about 50 or at least about 60 degrees lower than the heating step.

The heat treatment advantageously takes place for a period of time necessary to achieve an improvement in cycle life over the same electrode not so treated.

For example, the heat treatment is performed for a period of from about 20 seconds to about 60 minutes, from about 1 minute to about 50 minutes, from about 3 minutes to about 40 minutes or from about 10 minutes to about 30 minutes; or for a period of about 30 seconds or about 2, about 4, about 5, about 15, about 20, about 25, about 35, about 45 or about 55 minutes.

Exposure to heat via convection and/or radiant heat may require periods of from about 15 minutes to about 60 minutes, for example about 20 minutes, 25, minutes, 30 minutes, 35 minutes, 40 minutes, 45 minutes, 50 minutes or 55 minutes and times in between.

Exposure to heat via induction heating or combinations of induction heating with convection and/or radiant heat may require periods of from about 20 seconds to about 6 minutes, for instance from about 30 seconds to about 5 minutes, for instance for about 45 seconds, about 1 minute or about 2, about 3, about 4 or about 5 minutes. Exposure to one or more heating methods in combination with microwave radiation may also require these shorter time periods.

The temperature and time of the heat exposure is typically such that the polymeric binder “softens” or is partially melted. The polymeric binder may in some instances be completely melted.

The heat exposure may advantageously take place after any pressing step.

The electrolyte is an aqueous alkaline system, for example aqueous potassium hydroxide.

The separator is for instance a nonwoven web of natural or synthetic fibers. Natural fibers include cotton. Synthetic fibers include polyamide, polyster, polypropylene (PP), polyethylene (PE), PP/PE copolymer, PTFE, polyvinylchloride and glass.

The present cells exhibit markedly improved cycle life. The internal resistance is reduced and there is a lower voltage difference between charging and discharging. It may be that the heat exposure enhances the binding strength and conductivity networks of the electrodes. It may also be that the heat exposure results in an electrode that is more stable towards the electrolyte solution.

The term “a” referring to elements of an embodiment may mean “one” or “one or more”.

The term “about” refers to variation that can occur, for example, through typical measuring and handling procedures; through inadvertent error in these procedures; through differences in the manufacture, source, or purity of ingredients used; through differences in methods used; and the like. The term “about” also encompasses amounts that differ due to different equilibrium conditions for a composition resulting from a particular initial mixture. Whether or not modified by the term “about,” embodiments and claims include equivalents to the recited quantities.

All numeric values herein are modified by the term “about,” whether or not explicitly indicated. The term “about” generally refers to a range of numbers that one of skill in the art would consider equivalent to the recited value (i.e., having the same function and/or result). In many instances, the term “about” may include numbers that are rounded to the nearest significant figure.

A value modified by the term “about” of course includes the specific value. For instance, “about 5.0” must include 5.0.

U.S. patents, U.S. published patent applications and U.S. patent applications discussed herein are each hereby incorporated by reference.

### BRIEF DESCRIPTION OF THE DRAWINGS

FIG. 1 is a graph of capacity vs. cycle number for the inventive cells and control cell of Example 1.

FIG. 2 is a graph of voltage vs. capacity for a present cell heat treated at 150° C. vs. a control cell of Example 1.

The following are some embodiments of the invention.

### EMBODIMENT 1

A method for preparing a positive electrode for a metal hydride cell, the method comprising

applying a paste comprising an active positive electrode composition to a conductive substrate to obtain a pasted electrode and

exposing the pasted electrode to an elevated temperature of from about 130° C. to about 210° C., for instance from about 140° C. to about 190° C. or from about 140° C. to about 180° C.; or at a temperature of about 150° C., 160° C., 170° C. or 200° C.,

where the electrode composition comprises a particulate positive electrode active material, a polymeric binder and optionally one or more additives.

### EMBODIMENT 2

A method according to embodiment 1 comprising exposing the pasted electrode to the elevated temperature through convection heating, radiant heating, inductive heating or combinations thereof or through a combination of one or more of these with microwave radiation.

### EMBODIMENT 3

A method according to embodiments 1 or 2 where the binder is a thermoplastic polymer or an elastomer.

### EMBODIMENT 4

A method according to any of the preceding embodiments where the binder is selected from the group consisting of polyvinyl alcohol, polyethylene oxide, polypropylene oxide, polybutylene oxide, methyl cellulose, carboxymethyl cellulose, hydroxyethyl cellulose, hydroxypropyl cellulose, hydroxypropylmethyl cellulose, polyethylene, polypropylene, polyisobutylene, polyvinyl chloride, polyvinyliden chloride, polyvinyliden fluoride, polytetrafluoroethylene, fluorinated ethylene propylene, perfluroalkoxy, polyvinylacetate, polyvinyl isobutylether, polyacrylonitrile, polymethacrylonitrile, polymethylmethacrylate, polymethylacrylate, polyethyl methacrylate, allyl acetate, polystyrene, polybutadiene, polyisoprene, polyoxymethylene, polyoxyethylene, polycyclic thioether, polydimethylsiloxane, polyesters such as polyethylene terephthalate, polycarbonate, polyamide, blends and copolymers thereof; or is selected from the group consisting of styrene-butadiene copolymer, styrene-butadiene-styrene block copolymer, styrene-isoprene block copolymer, styrne-isoprene-styrene block copolymer, styrene-ethylene-styrene-butadiene block copolymer, styrene-ethylene-butadiene-styrene block copolymer and styrene-acrylonitrile-butadiene-methyl acrylate copolymer.

### EMBODIMENT 5

A method according to any of the preceding embodiments where the binder is polyvinyl alcohol.

### EMBODIMENT 6

A method according to any of the preceding embodiments where electrode composition comprises from about 75 to about 99.8 wt % electrode active material, from about 0.2 to about 10 wt % polymeric binder and from 0 to about 24.8 wt % additives, based on the weight of the electrode composition.

### EMBODIMENT 7

A method according to any of the preceding embodiments where the polymeric binder is present in the electrode composition at a weight level of about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0 or about 2.1 wt %, based on the weight of the electrode composition.

### EMBODIMENT 8

A method according to any of the preceding embodiments where the conductive substrate is an electronically conductive material in the form of a foam, grid, screen, mesh, matte, plate, fiber, foil or expanded metal.

### EMBODIMENT 9

A method according to any of the preceding embodiments where the conductive substrate is a nickel foam.

### EMBODIMENT 10

A method according to any of the preceding embodiments where the paste further comprises a solvent and where the pasted electrode is dried after application and prior to the exposure step.

### EMBODIMENT 11

A method for preparing a positive electrode for a metal hydride cell, the method comprising

applying a paste comprising an active positive electrode composition to a conductive nickel foam substrate to obtain a pasted electrode and

exposing the pasted electrode to an elevated temperature of from about 130° C. to about 210° C., for instance from about 140° C. to about 190° C. or from about 140° C. to about 180° C.; or at a temperature of about 150° C., 160° C., 170° C. or 200° C.,

where the electrode composition comprises a particulate positive electrode active material and optionally one or more additives.

### EMBODIMENT 12

A method according to any of the preceding embodiments, where the exposure is performed for a period of from about 20 seconds to about 60 minutes, from about 1 minute to about 50 minutes, from about 3 minutes to about 40 minutes or from about 10 minutes to about 30 minutes; or for a period of about 30 seconds or about 2, about 4, about 5, about 15, about 20, about 25, about 35, about 45 or about 55 minutes.

### EMBODIMENT 13

A method according to any of the preceding embodiments where the electrode active material is nickel hydroxide or modified nickel hydroxide.

### EMBODIMENT 14

A method according to any of embodiments 11-13 where electrode composition comprises from about 75 to 100 wt % electrode active material and from 0 to about 25 wt % additives, based on the weight of the electrode composition.

### EMBODIMENT 15

A method according to any of the preceding embodiments comprising a pressing step after the pasting step and prior to the exposure step.

### EMBODIMENT 16

A method according to any of the preceding embodiments where the electrode active material is in the form of platelets, scales, flakes, fibers or spheres.

### EMBODIMENT 17

A method according to any of the preceding embodiments where the electrode active material is in the form of substantially spherical particles with an average diameter of from about 0.1 to about 100 microns.

### EMBODIMENT 18

A method according to any of the preceding embodiments where the electrode composition comprises one or more additives; for instance one or more additives selected from the group consisting of cobalt compounds, zinc compounds, rare earth compounds and carbon materials.

### EMBODIMENT 19

A metal hydride battery comprising at least one negative electrode, at least one positive electrode, a casing having said electrodes positioned therein, a separator separating the negative and positive electrodes and an alkaline electrolyte in contact with the electrodes, wherein the at least one positive electrode is prepared by the method according to any of the preceding embodiments.

### EMBODIMENT 20

An electrode prepared according to the method of any of embodiments 1 to 18.

### EXAMPLE 1

Size C cells are prepared with a dry compacted negative electrode with a rare earth nickel based AB₅ hydrogen storage material, a pasted (Ni,Co,Zn)(OH)₂ positive electrode, 30% aqueous KOH electrolyte and a polypropylene/polyethylene grafted nonwoven fabric separator.

The positive electrode is prepared from a paste of virgin modified nickel hydroxide (Ni,Co,Zn)(OH)₂ spherical powder active material, Co and CoO additives and PVA binder polymer. The substrate is a nickel foam. The paste contains 5% Co, 6% CoO, 0.3% PVA, 5% water, 25% ethanol and remainder (Ni,Co,Zn)(OH)₂ powder, by weight based on the weight of the paste. The PVA has a Mw of less than or equal to 26,000 g/mol.

The positive pasted electrodes are dried in an oven set at 86° C. for 30 minutes.

The cells have a nominal capacity of 4.2 Ah.

In the inventive cells the positive pasted electrodes are heat treated for 30 minutes in an oven at 150° C. and 170° C., respectively. In the control cell the positive electrode is not heat treated.

Cycle life testing is conducted using an Arbin MSTAT system. The system contains 8 independently controlled channels capable of −10 to +10 Volts and 5.0 amps of current both in charge and discharge. The cells are connected to individual channels and cycled using C/2 charge to 1.5 Volts cutout before about 200 cycles and to 4.2 Ah cutout (100% capacity) after about 200 cycles. The cell is then discharged using a C/2 rate to a cutout of 1.0 Volts. Cells are continuously cycled (approx. 5 cycles per day).

Within about 200 cycles, cells are not fully charged due to 1.5 V cutout. The capacities increase with cycles as internal resistance decreases and charging capacities increases. In some cells, capacities start to drop, indicating internal resistance increases with cycles. Capacities of cells are recovered by charging capacity 4.2 Ah cutout.

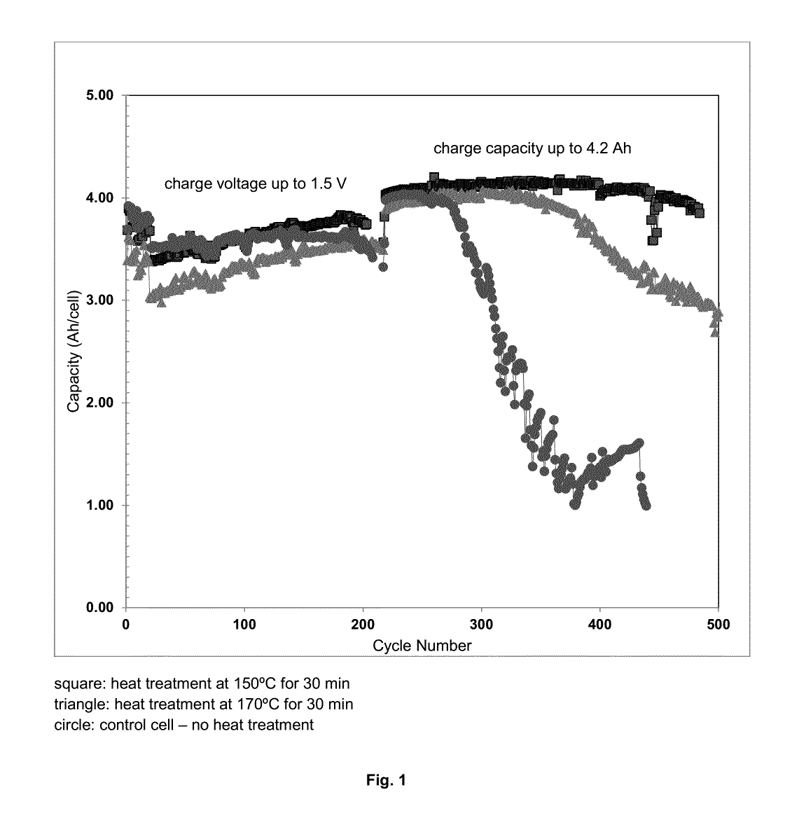

Inventive cells demonstrate excellent cycle life compared to the control cell. Results of capacity vs. cycle number are found in FIG. 1.

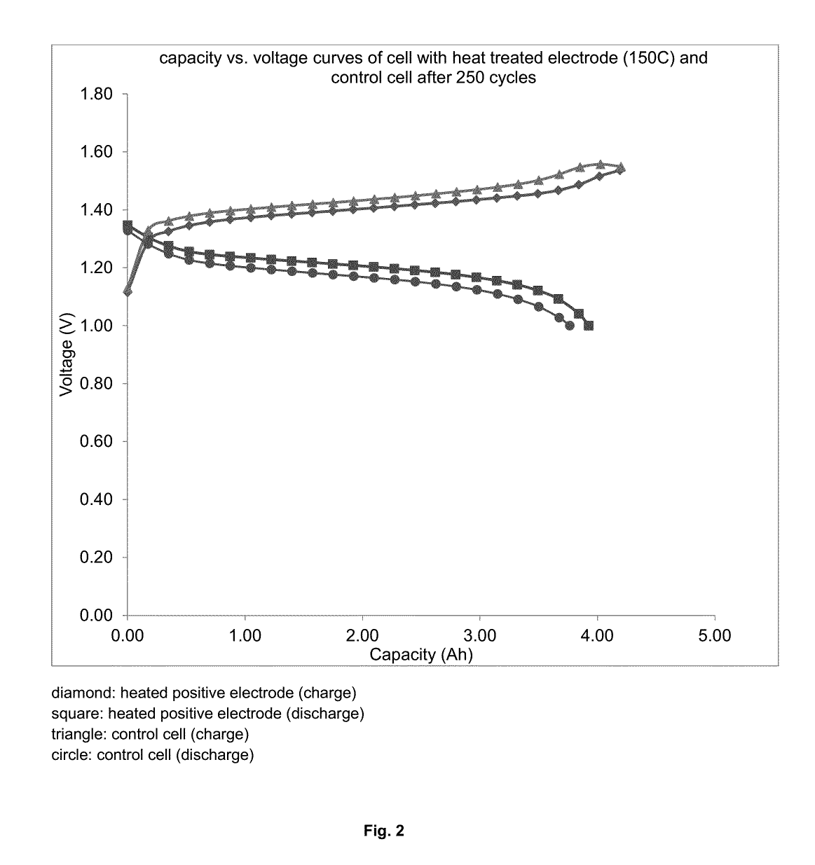

FIG. 2 is a graph of voltage vs. capacity after 250 cycles. It is seen from charging and discharging curves of present cell with heat treated positive electrode (150° C.) and of the control cell, that the present cell has lower charging voltage and higher discharging voltage, indicating lower internal resistance and higher efficiency of energy utilization.

### EXAMPLE 2

Example 1 is repeated, but where the positive electrode compositions contain no binder polymer.

### EXAMPLE 3

Examples 1 and 2 are repeated, but where the paste electrodes are heat treated with an infrared lamp or an induction oven.

1. A method for preparing a positive electrode for a metal hydride cell, the method comprising
applying a paste comprising an active positive electrode composition to a conductive substrate to obtain a pasted electrode and
exposing the pasted electrode to an elevated temperature of from about 130° C. to about 210° C.,
where the electrode composition comprises a particulate positive electrode active material, a polymeric binder and optionally one or more additives.

2. A method according to claim 1 comprising exposing the pasted electrode to the elevated temperature through convection heating, radiant heating, inductive heating or combinations thereof or through a combination of one or more of these with microwave radiation.

3. A method according to claim 1 where the binder is a thermoplastic polymer or an elastomer.

4. A method according to claim 1 where the binder is selected from the group consisting of polyvinyl alcohol, polyethylene oxide, polypropylene oxide, polybutylene oxide, methyl cellulose, carboxymethyl cellulose, hydroxyethyl cellulose, hydroxypropyl cellulose, hydroxypropylmethyl cellulose, polyethylene, polypropylene, polyisobutylene, polyvinyl chloride, polyvinyliden chloride, polyvinyliden fluoride, polytetrafluoroethylene, fluorinated ethylene propylene, perfluroalkoxy, polyvinylacetate, polyvinyl isobutylether, polyacrylonitrile, polymethacrylonitrile, polymethylmethacrylate, polymethylacrylate, polyethylmethacrylate, allyl acetate, polystyrene, polybutadiene, polyisoprene, polyoxymethylene, polyoxyethylene, polycyclic thioether, polydimethylsiloxane, polyesters such as polyethylene terephthalate, polycarbonate, polyimide, blends and copolymers thereof; or is selected from the group consisting of styrene-butadiene copolymer, styrene-butadiene-styrene block copolymer, styrene-isoprene block copolymer, styrne-isoprene-styrene block copolymer, styrene-ethylene-styrene-butadiene block copolymer, styrene-ethylene-butadiene-styrene block copolymer and styrene-acrylonitrile-butadiene-methyl acrylate copolymer.

5. A method according to claim 1 where the binder is polyvinyl alcohol.

6. A method according to claim 1 where electrode composition comprises from about 75 to about 99.8 wt % electrode active material, from about 0.2 to about 10 wt % polymeric binder and from 0 to about 24.8 wt % additives, based on the weight of the electrode composition.

7. A method according to claim 1 where the polymeric binder is present in the electrode composition at a weight level of from about 0.2 to about 2.1 wt %, based on the weight of the electrode composition.

8. A method according to claim 1 where the conductive substrate is an electronically conductive material in the form of a foam, grid, screen, mesh, matte, plate, fiber, foil or expanded metal.

9. A method according to claim 1 where the conductive substrate is a nickel foam.

10. A method according to claim 1 where the paste further comprises a solvent and where the pasted electrode is dried after application and prior to the exposure step.

11. A method for preparing a positive electrode for a metal hydride cell, the method comprising
applying a paste comprising an active positive electrode composition to a conductive nickel foam substrate to obtain a pasted electrode and
exposing the pasted electrode to an elevated temperature of from about 130° C. to about 210° C.,
where the electrode composition comprises a particulate positive electrode active material and optionally one or more additives.

12. A method according to claim 1, where the exposure is performed for a period of from about 20 seconds to about 60 minutes.

13. A method according to claim 1 where the electrode active material is nickel hydroxide or modified nickel hydroxide.

14. A method according to claim 11 where electrode composition comprises from about 75 to 100 wt % electrode active material and from 0 to about 25 wt % additives, based on the weight of the electrode composition.

15. A method according to claim 1 comprising a pressing step after the pasting step and prior to the exposure step.

16. A method according to claim 1 where the electrode active material is in the form of platelets, scales, flakes, fibers or spheres.

17. A method according to claim 1 where the electrode active material is in the form of substantially spherical particles with an average diameter of from about 0.1 to about 100 microns.

18. A method according to claim 1 where the electrode composition comprises one or more additives selected from the group consisting of cobalt compounds, zinc compounds, rare earth compounds and carbon materials.

19. A metal hydride battery comprising at least one negative electrode, at least one positive electrode, a casing having said electrodes positioned therein, a separator separating the negative and positive electrodes and an alkaline electrolyte in contact with the electrodes, wherein the at least one positive electrode is prepared by the method according to claim 1.

20. An electrode prepared according to the method of claim 1.
